(19) United States
(12) Patent Application Publication
(10) Pub. No.: US 2015/0370003 A1
(43) Pub. Date: Dec. 24, 2015

(54) LIGHT STRIP, BACKLIGHT AND DISPLAY DEVICE

(71) Applicants: BOE TECHNOLOGY GROUP CO., LTD., BEIJING (CN); BEIJING BOE DISPLAY TECHNOLOGY CO., LTD., BEIJING (CN)

(72) Inventors: HONGLI ZHU, BEIJING (CN); LILI JIA, BEIJING (CN); ZHIDAN ZHANG, BEIJING (CN); DAEKEUN YOON, BEIJING (CN)

(73) Assignees: BOE TECHNOLOGY GROUP CO., LTD., BEIJING (CN); BEIJING BOE DISPLAY TECHNOLOGY CO., LTD., BEIJING (CN)

(21) Appl. No.: 14/495,051

(22) Filed: Sep. 24, 2014

(30) Foreign Application Priority Data
Jun. 24, 2014 (CN) 201410289573.0

(51) Int. Cl. F21V 8/00; F21S 4/00

(52) U.S. Cl. CPC G02B 6/0073; F21S 4/008; G02B 6/0065; G02B 6/0068

(57) ABSTRACT

The present disclosure relates to a light strip, comprising a substrate and a plurality of LED lights provided on the substrate, wherein, at least two rows of LED lights are provided on the substrate, two adjacent rows of LED lights are staggered arranged. The present disclosure further relates to a backlight and a display device.

### CROSS-REFERENCE TO RELATED APPLICATION

This application claims priority to Chinese Patent Application No. 201410289573.0 filed on Jun. 24, 2014, the disclosures of which are incorporated in their entirety by reference herein.

### TECHNICAL FIELD

The present disclosure relates to the technical field of a liquid crystal display, particularly to a light strip, a backlight and a display device.

BACKGROUND

As shown in FIG. 1 and FIG. 2, a conventional edge backlight structure includes a light guide plate 1 and a light strip 2 arranged on a light incident side of the light guide plate 1. The structure of the conventional backlight has problems as follows.

(1) Nowadays, there has been an extensive demand for a 3D liquid crystal display (LCD) product; however, because of the limitation in principle of a 3D display, half of the brightness is lost when assembling a 3D display panel, even if the brightness of the backlight is high. Therefore, a backlight having higher brightness is required so as to get a 3D LCD product with high brightness.

In an actual product, the number of light emitting diodes (LEDs) cannot be infinite and the arrangement thereof cannot be with an infinitely dense, due to the restrictions of the arrangement of LED lights. Therefore, the room for improving the brightness of the backlight with the conventional backlight structure is very limited.

(2) A poor display having hotspot may occur in the structure of the conventional edge backlight. As shown in FIG. 2, a light-emitting angle of a LED light in general is 120°. Therefore there is a dead angle between two LED lights 21, where no light can reach and it is dark. However, if the light guide plate gets too close to the LED lights 21, the phenomenon of nonuniform brightness and darkness appears on a LCD display, resulting in the poor display having hotspot.

### SUMMARY

To solve the above problems, the present disclosure provides a light strip, a backlight and a display device.

To achieve the above object, the present disclosure provides a light strip, comprising a substrate and a plurality of LED lights provided on the substrate, wherein, at least two rows of LED lights are provided on the substrate, two adjacent rows of LED lights are staggered arranged.

Alternatively, the substrate comprises at least two sub-substrates, a row of LED lights are provided on each of the at least two sub-substrates, the LED lights on two adjacent sub-substrate are staggered arranged.

Alternatively, the substrate comprises at least two sub-substrates, at least two rows of LED lights are provided on each of the at least two sub-substrates, wherein one row of LED lights on one sub-substrate are staggered arranged with another row of LED lights on another sub-substrate adjacent to the one sub-substrate and the position of the one row of LED lights corresponds to the position of the another row of LED lights.

The present disclosure also provides a backlight, comprising a light guide plate, a rubber frame, and a backplane provided on periphery of the light guide plate and the rubber frame, wherein, the backlight further comprises the light strip as described above, the light strip is arranged opposite to a light incident surface of the light guide plate.

Alternatively, the substrate comprises at least two sub-substrates, at least one row of LED lights are provided on each of the at least two sub-substrates, wherein one row of LED lights on one sub-substrate of the at least two sub-substrates are staggered arranged with another row of LED lights on another sub-substrate of the at least two sub-substrates adjacent to the one sub-substrate and the position of the one row of LED lights corresponds to the position of the another row of LED lights.

Alternatively, the angle between the one sub-substrate of the at least two sub-substrates and the another sub-substrate of the at least two sub-substrates is 90 to 180 degree.

Alternatively, the light incident surface of the light guide plate comprises a plurality of sub-light incident surfaces, the number of the plurality of sub-light incident surfaces corresponds to the number of the sub-substrates, each of the sub-incident surfaces is arranged parallel to a corresponding sub-substrate.

Alternatively, the rubber frame comprises a plurality of connecting surfaces, which are used for connecting the sub-substrates and the number of the plurality of connecting surfaces corresponds to the number of the sub-substrates, each of the connecting surfaces is arranged parallel to a corresponding sub-substrate.

Alternatively, one part of the sub-substrates are fixed to the rubber frame, another part of the sub-substrates are fixed to the backplane, the connecting surface on the rubber frame for connecting the sub-substrate is arranged parallel to a corresponding sub-substrate, the connecting surface on the backplane for connecting the sub-substrate is arranged parallel to a corresponding sub-substrate.

Alternatively, the sub-substrate is fixed on the backplane and/or the rubber frame by an adhesive member.

Alternatively, wherein the adhesive member is a double-sided adhesive.

The present disclosure also provides a display device, comprising the backlight as described above.

The advantageous effect of the present disclosure is that the LEDs are staggered arranged so that the nonuniform display caused by the hotspot phenomenon can be avoided.

### BRIEF DESCRIPTION OF THE DRAWINGS

FIG. 1 is a schematic diagram illustrating a structure of a backlight in the prior art.

FIG. 2 is a schematic diagram illustrating a light-emitting state of a LED in the prior art.

FIG. 3 is a schematic diagram illustrating a staggered arrangement of the LEDs on light strips according to the present disclosure.

FIG. 4 is a schematic diagram illustrating a structure of a backlight according to the present disclosure.

FIG. 5 is a partial enlarged schematic view of FIG. 4.

FIG. 6 is a schematic diagram illustrating another structure of a backlight according to the present disclosure.

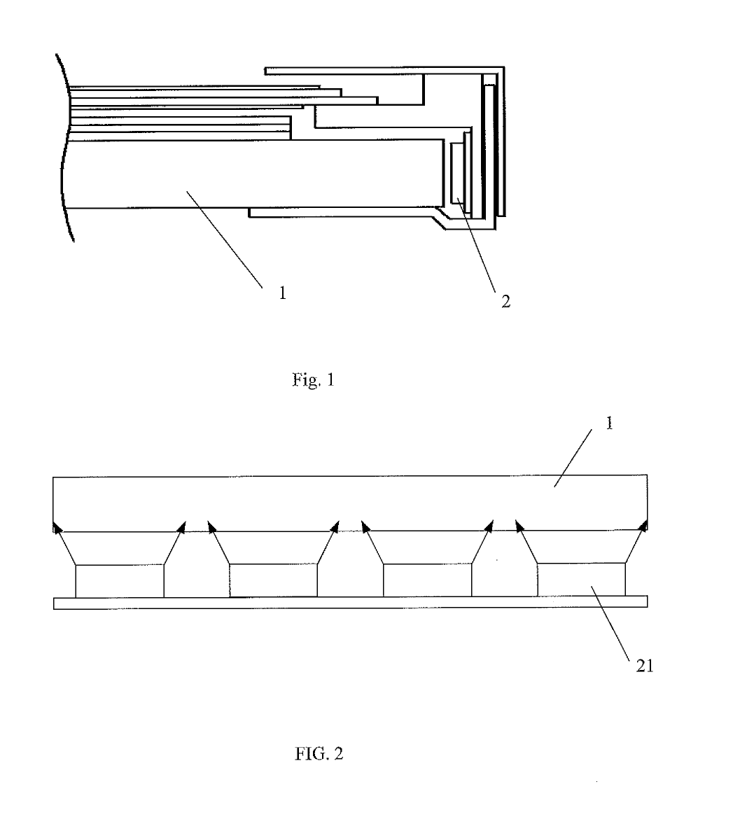

### DETAILED DESCRIPTION

The structure and the principle of the present disclosure will be described below in detail, in conjunction with the accompanying drawings. The illustrated embodiment is only intended to explain the present disclosure, but not to limit the scope of the present disclosure.

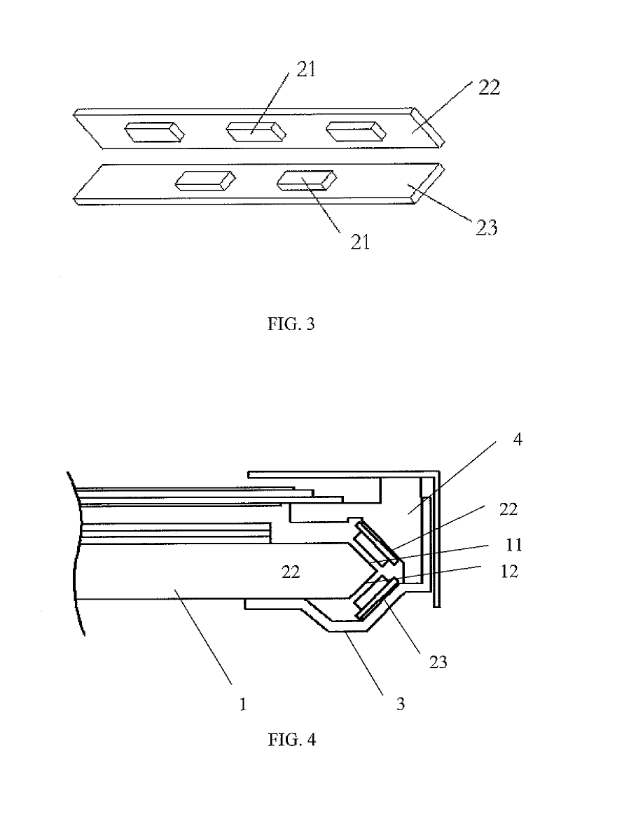

As shown in FIG. 3, the present embodiment provides a light strip, including a substrate and a plurality of LED lights 21 provided on the substrate. At least two rows of the LED lights 21 are provided on the substrate, two adjacent rows of LED lights 21 being staggered arranged.

Due to the staggered arrangement of the LED lights, dark areas on one light strip can be illuminated by LED lights on another light strip, so that the brightness of a backlight can be significantly increased, and the nonuniform display caused by the hotspot phenomenon can also be avoided.

The light strip may include one substrate, on which at least two rows of LED lights 21 are provided, wherein two adjacent rows of LED lights 21 are staggered arranged; the substrate may also be composed by at least two sub-substrates, one row of LED lights 21 may be provided on each sub-substrate, and the LED lights 21 on tow adjacent sub-substrates are staggered arranged; the substrate may also be composed by at least two sub-substrates, at least two rows of LED lights 21 may be provided on each sub-substrate, wherein one row of LED lights 21 on one sub-substrate are staggered arranged with another row of LED lights 21 on another sub-substrate adjacent to the one sub-substrate and the position of the one row of LED lights 21 corresponds to the position of the another row of LED lights 21.

The present disclosure also provides a backlight, including a light guide plate 1, a rubber frame 4, and a backplane provided on periphery of the light guide plate 1 and the rubber frame 4. The backlight further includes the light strip as described above, which is arranged opposite to a light incident surface of the light guide plate 1.

At least two rows of LED lights 21 on the light strip is staggered arranged, as viewed in space, so that the brightness of the backlight can be significantly increased, and the nonuniform display of the backlight caused by the hotspot phenomenon can also be avoided.

Further, the substrate includes at least two sub-substrates, at least one row of LED lights 21 is provided on each sub-substrate, wherein one row of LED lights 21 on a first sub-substrate 22 is staggered arranged with another row of LED lights 21 on a corresponding position on a second sub-substrate 23 opposite to the first sub-substrate 22. The angle between the first sub-substrate 22 and the second sub-substrate 23 is 90 to 180 degree.

Further, the light incident surface of the light guide plate 1 includes a plurality of sub-light incident surfaces, the number of which corresponds to the number of the sub-substrates, each of the sub-light incident surfaces being arranged parallel to a corresponding sub-substrate.

Further, the rubber frame 4 includes a plurality of connecting surfaces, which is used for connecting the sub-substrate and the number of connecting surfaces corresponds to the number of the sub-substrates, each of the connecting surfaces being arranged parallel to a corresponding sub-substrate.

Further, one part of the sub-substrates are fixed to the rubber frame 4, another part of the sub-substrates are fixed to the backplane 3. The connecting surface on the rubber frame 4 for connecting the sub-substrate is arranged parallel to a corresponding sub-substrate. The connecting surface on the backplane 3 for connecting the sub-substrate is arranged parallel to a corresponding sub-substrate.

The number of the sub-substrates and the number of rows of LED lights 21 provided on each sub-substrate can be set according to actual needs. The structure of the backlight of the present embodiment will be described below in detail by taking an example that each of the substrates includes two sub-substrates, i.e. the first sub-substrate 22 and the second sub-substrate 23, a row of LED lights 21 are provided each of the first sub-substrate 22 and the second sub-substrate 23.

The first sub-substrate 22 and the second sub-substrate 23 are arranged at a light incident side of the light guide plate 1 with a certain angle. The first sub-substrate 22 and the second sub-substrate 23 may be arranged on the rubber frame 4 and the backplane 3 respectively, and may also be both arranged on the rubber frame 4. In order to ensure a propagation of light along the light guide plate 1 smoothly and to achieve a high utilization rate of light, the angle between the two LED lights 21 stripes is 90 degree at minimum, and 180 degree at maximum. the light incident surface of the light guide plate 1 can be made to different shapes, so as to match to the positions of the first sub-substrate 22 and the second sub-substrate 23.

FIG. 3 illustrates a staggered arrangement of LED lights 21 on the first sub-substrate 22 and the second sub-substrate 23 arranged with an angle. The position of an LED light 21 on the first sub-substrate 22 corresponds to a region between two adjacent LED lights 21 on the second sub-substrate 23, that is, the light of LED lights 21 on the first sub-substrate 22 can illuminate the dark areas where the light of LED lights 21 on the second sub-substrate 23 cannot reach, so as to eliminate the hotspot phenomenon effectively and make the display more uniform. Similarly, the position of an LED light 21 on the second sub-substrate 23 corresponds to a region between two adjacent LED lights 21 on the first sub-substrate 22, that is, the light of LED lights 21 on the second sub-substrate 23 can irradiate the dark areas where the light of LED lights 21 on the first sub-substrate 22 cannot reach, so as to eliminate the hotspot phenomenon effectively and make the display more uniform.

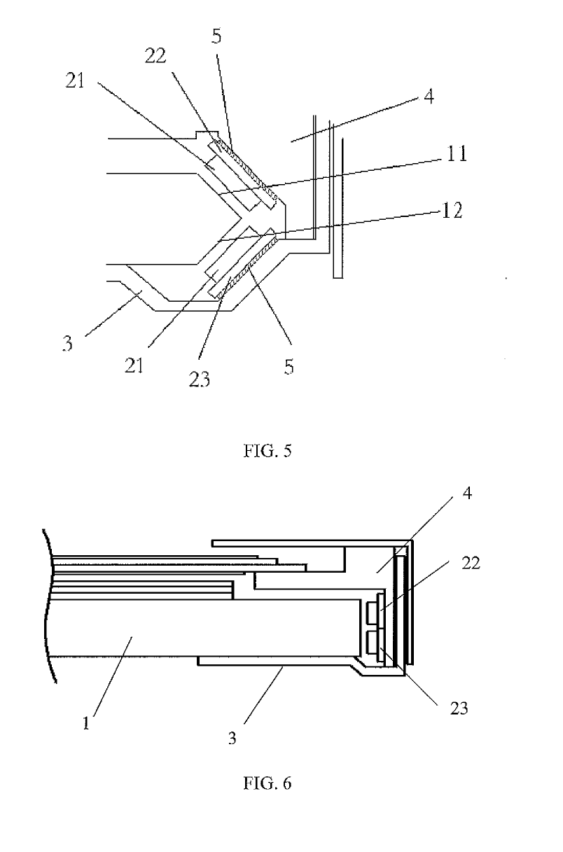

FIG. 4 is a schematic view showing that the angle between the first sub-substrate 22 and the second sub-substrate 23 is 90 degree, and FIG. 5 is a partial enlarged schematic view of FIG. 4. In the present embodiment, there are two sub-substrates, i.e. the first sub-substrate 22 and the second sub-substrate 23, arranged with an angle of 90 degree, at the light incident side of the light guide plate 1. The light incident surface of the light guide plate 1 includes a first surface 11 arranged opposite and parallel to the first sub-substrate 22, and a second face 12 arranged opposite and parallel to the second sub-substrate 23, that is, the first surface 11 and the second surface 12 are arranged at an angle of 90 degree, to fully utilize the light emitted from the LED light 21. The first sub-substrate 22 is fixed on the rubber frame 4 by an adhesive member 5, for example, a double-sided adhesive; similarly, the second sub-substrate 23 is fixed on the backplane 3 by the adhesive member 5, for example, the double-sided adhesive.

FIG. 6 is a schematic view showing that the angle between the first sub-substrate 22 and the second sub-substrate 23 is 180 degree. In the present embodiment, there are two sub-substrates, i.e. the first sub-substrate 22 and the second sub-substrate 23, arranged with an angle of 180 degree, at the light incident side of the light guide plate 1. The light incident surface of the light guide plate 1 is a planar structure arranged parallel to the first sub-substrate 22 and the second sub-substrate 23, to fully utilize the light emitted from the LED light 21. The first sub-substrate 22 and the second sub-substrate 23 are fixed on the rubber frame 4 by the adhesive member 5, for example, the double-sided adhesive.

The present disclosure also provides a display device, including the backlight as described above.

The above-described are preferred embodiments of the present disclosure. It should be noted that improvements and modifications also can be made for one ordinary skilled in the art, without departing from the principles of the present disclosure, and these improvements and modifications should also be regarded as falling within the scope of the disclosure.

What is claimed is:

1. A light strip, comprising a substrate and a plurality of LED lights provided on the substrate, wherein, at least two rows of LED lights are provided on the substrate, two adjacent rows of LED lights are staggered arranged.

2. The light strip according to claim 1, wherein, the substrate comprises at least two sub-substrates, a row of LED lights are provided on each of the at least two sub-substrates, the LED lights on two adjacent sub-substrate are staggered arranged.

3. The light strip according to claim 1, wherein, the substrate comprises at least two sub-substrates, at least two rows of LED lights are provided on each of the at least two sub-substrates, wherein one row of LED lights on one sub-substrate are staggered arranged with another row of LED lights on another sub-substrate adjacent to the one sub-substrate and the position of the one row of LED lights corresponds to the position of the another row of LED lights.

4. A backlight, comprising a light guide plate, a rubber frame, and a backplane provided on periphery of the light guide plate and the rubber frame, wherein, the backlight further comprises the light strip according to claim 1, the light strip is arranged opposite to a light incident surface of the light guide plate.

5. The backlight according to claim 4, wherein, the substrate comprises at least two sub-substrates, at least one row of LED lights are provided on each of the at least two sub-substrates, wherein one row of LED lights on one sub-substrate of the at least two sub-substrates are staggered arranged with another row of LED lights on another sub-substrate of the at least two sub-substrates adjacent to the one sub-substrate and the position of the one row of LED lights corresponds to the position of the another row of LED lights.

6. The backlight according to claim 5, wherein, the angle between the one sub-substrate of the at least two sub-substrates and the another sub-substrate of the at least two sub-substrates is 90 to 180 degree.

7. The backlight according to claim 5, wherein, the light incident surface of the light guide plate comprises a plurality of sub-light incident surfaces, the number of the plurality of sub-light incident surfaces corresponds to the number of the sub-substrates, each of the sub-incident surfaces is arranged parallel to a corresponding sub-substrate.

8. The backlight according to claim 5, wherein, the rubber frame comprises a plurality of connecting surfaces, which are used for connecting the sub-substrates and the number of the plurality of connecting surfaces corresponds to the number of the sub-substrates, each of the connecting surfaces is arranged parallel to a corresponding sub-substrate.

9. The backlight according to claim 5, wherein, one part of the sub-substrates are fixed to the rubber frame, another part of the sub-substrates are fixed to the backplane, the connecting surface on the rubber frame for connecting the sub-substrate is arranged parallel to a corresponding sub-substrate, the connecting surface on the backplane for connecting the sub-substrate is arranged parallel to a corresponding sub-substrate.

10. The backlight according to claim 9, wherein, the sub-substrate is fixed on the backplane and/or the rubber frame by an adhesive member.

11. The backlight according to claim 10, wherein the adhesive member is a double-sided adhesive.

12. A display device, comprising the backlight according to claim 4.
